(19) United States
(12) Patent Application Publication
(10) Pub. No.: US 2024/0078562 A1
(43) Pub. Date: Mar. 7, 2024

(54) System Incenting Corn Farmers to Improve the Environment

(71) Applicant: Frank T. O'Keefe, Lloyd Harbor, NY (US)

(72) Inventor: Frank T. O'Keefe, Lloyd Harbor, NY (US)

(21) Appl. No.: 18/459,945

(22) Filed: Sep. 1, 2023

Related U.S. Application Data
(60) Provisional application No. 63/374,523, filed on Sep. 2, 2022.

(51) Int. Cl. G06Q 30/018; H02S 20/10

(52) U.S. Cl. CPC G06Q 30/018; H02S 20/10; G06Q 50/02

(57) ABSTRACT

A system incenting farmers to improve the environment by removing CO2 from the atmosphere and generating electricity on the same portion of their arable land is disclosed, having a plurality of solar panels installed on at least a portion of a farmer's arable land, prairie grass planted beneath said plurality of solar panels and displacing a crop on the portion of the farmer's arable land, electricity generated by said solar panels either utilized by the farmer or sold to a utility, a computer receiving a signal indicative of the amount of arable land replanted with said prairie grass and the crop displaced, and a carbon offset credit calculated by said computer and owed to the farmer reflecting the amount of CO2 stored by the prairie grass on the farmer's arable land.

### TECHNICAL FIELD

The present invention relates to a novel system incentivizing corn farmers to improve the environment. Specifically, the system is used to incent farmers to replace a portion of their arable land with high-photosynthetically efficient grasses and solar panels.

### BACKGROUND

Earth's systems evolved over 3.8 billion years to drawdown CO2 from air to create and nourish life. Planetary recovery relies on our ability to harness that capability to enrich grasslands, build soil, and sequester carbon, especially given government inaction to address climate change.

The photosynthetic efficiency is the fraction of light energy converted into chemical energy during photosynthesis in green plants and algae. Typical plants are less than 0.1% efficient in their photosynthetic processes. Some plants can be 3.5% or even over 4% efficient. Researches are working to determine ways to breed higher-efficient plants, such as miscanthus x giganteus. As scientists determine how to further raise the photosynthetic efficiency of these plants and improve carbon utilization, systems will be needed to devote arable land to remedy climate change.

Many grasses, including prairie grasses, also thrive with less sunlight than more common crops. As a result, the carbon savings from planting plants that are photosynthetically efficient can be coupled with another climate change solution—solar panels. Solar panels can be planted over or around these photosynthetically efficient plants to not only draw CO2 from the atmosphere, but by creating renewable energy at the same time.

### SUMMARY

For these and other reasons known to a person of an ordinary skill in the art, what is needed is a system incentivizing green energy usage.

A goal of the present invention is to promote the adoption of solar panels by farmers.

A goal of the present invention is to promote the adoption of planting photosynthetically efficient plants by farmers.

Another goal of the present invention is to provide a lower cost of entry for sustainable and environmentally-sound practices.

In one aspect of the present invention, a system incenting farmers to improve the environment by removing CO2 from the atmosphere and generating electricity on the same portion of their arable land is disclosed. The system may have a plurality of solar panels installed on at least a portion of a farmer's arable land. Prairie grass is planted beneath said plurality of solar panels and displacing a crop on the portion of the farmer's arable land. Electricity generated by said solar panels is either utilized by the farmer or sold to a utility. A computer receives a signal indicative of the amount of arable land replanted with said prairie grass and the crop displaced. A carbon offset credit is calculated by said computer and owed to the farmer reflecting the amount of CO2 stored by the prairie grass on the farmer's arable land.

### BRIEF DESCRIPTION OF THE DRAWINGS

FIG. 1 shows a schematic diagram of the presently disclosed system.

### DETAILED DESCRIPTION

The presently disclosed system will now be described by referencing the appended figures.

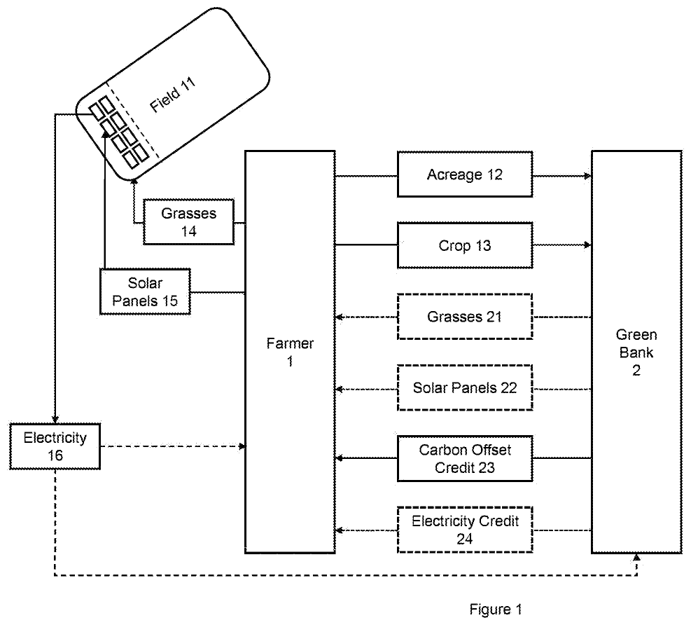

Referring to FIG. 1, the present disclosure describes a system 10 for incentivizing improvement of the environment.

The system 10 includes a farmer 1 and a green bank 2.

The farmer 1 may be an individual farmer, a group of farmers, or a farming organization. The farmer 1 may have a computer or other electronic device for communication with the system 10. The farmer 1 may include a processor, computer, remote computer, computer server, network, or any other computing resource.

The green bank 2 may be an organization or multiple organizations the facilitate improvement of the environment. The green bank 2 may have a computer or other electronic device for communication with the system 10. The green bank 2 may include a processor, computer, remote computer, computer server, network, or any other computing resource.

The farmer 1 may have a field 11. The field 11 may be used to grow crops, such as but not limited to corn or soybean.

The farmer 1 may provide the green bank 2 with information regarding the field 11, such as the acreage 12 and the crops currently grown on the field 13 (and the percentage of the field they take up). Other information, such as crop potential, soil or crop viability, soil chemical balances, etc. may also be provided. The green bank 2 may also receive information regarding the electricity output 16 of the solar panels 15.

The green bank 2, upon receiving the information regarding the field 11, may calculate a certain portion of the field 11 that may be replaced by solar panels and perennial grasses. Alternatively, the farmer 1 may provide the green bank 2 with an area of the field 11 that was or may be replaced by solar panels and perennial grasses.

The green bank 2 may provide the solar panels 22 and seeds for grasses 21 to the farmer 1. Alternatively, the green bank 2 may provide access to discounted solar panels 22 or seeds for grasses 21. Discounts may be based on estimated carbon offset credits 23 or estimated electricity credits 24.

Grasses 14 and solar panels 15 may be planted and installed on the field 11. Grasses 14 may include any type of grass, preferably perennial, high-photosynthesis, non-invasive grasses.

The green bank 2 may calculate carbon offset credits 23 for planting the grasses 14 on at least a portion of the field 11. The carbon offset credits 23 may be based on the amount of land used for growing the grasses 14, the crops that were replaced, and the grasses that were planted, the amount of CO2 stored by the grasses 14, or some other metric.

The green bank 2 may calculate electricity credits 24 for installing the solar panels 15 on at least a portion of the field 11. The electricity credits 24 may be based on the amount of electricity 16 generated by the solar panels 15, the amount of electricity 16 provided to a utility from the solar panels 15, or some other metric.

The carbon offset credits 23 and electricity credits 24 may be a single renewable energy credit. The electricity credits 24 and electricity credits 24 may be provided to the farmer 1 as cash, as a discount on future goods or services, or as a credit to a farmer's account at the bank.

The green bank 2 may sell carbon offsets based on the generated electricity or amount of CO2 stored by the grasses 14, e.g., to fund the credits paid to the farmers.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect. The present disclosure is to be considered as an example of the invention, and is not intended to limit the invention to a specific embodiment illustrated by the figures above or description below.

For purposes of explanation and not limitation, specific details are set forth such as particular architectures, interfaces, techniques, etc. to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first, “second,” etc. for different features/components of the present disclosure are only intended to distinguish the features/components from other similar features/components and not to impart any order or hierarchy to the features/components. As used herein, the term “and/or” includes any and all combinations of one or more of the associated listed items. As used herein, the term “application” is intended to be interchangeable with the term “invention”, unless context clearly indicates otherwise.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one, more, or all of the other disclosed techniques. Accordingly, for the sake of clarity, this description refrains from repeating every possible combination of the individual steps in an unnecessary fashion. Nevertheless, the specification and claims should be read with the understanding that such combinations are entirely within the scope of the invention and the claims.

1. A system incenting farmers to improve the environment by removing CO2 from the atmosphere and generating electricity on the same portion of their arable land, comprising: a plurality of solar panels installed on at least a portion of a farmer's arable land;
prairie grass planted beneath said plurality of solar panels and displacing a crop on the portion of the farmer's arable land;
electricity generated by said solar panels either utilized by the farmer or sold to a utility;
a computer receiving a signal indicative of the amount of arable land replanted with said prairie grass and the crop displaced; and
a carbon offset credit calculated by said computer and owed to the farmer reflecting the amount of CO2 stored by the prairie grass on the farmer's arable land.

2. The system of claim 1, wherein the crop is corn or soybean.

3. The system of claim 1, wherein said computer calculates a credit owed to the farmer for electricity supplied to the utility.

4. The system of claim 1, wherein said computer is associated with a financial institution that deals in carbon offsets.

5. The system of claim 1 in which said computer sells carbon offsets to fund the credits paid to farmers.

6. The system of claim 1, further comprising an electricity credit calculated by said computer and owed to the farmer reflecting the amount of electricity generated by the plurality of solar panels.

7. The system of claim 1, further comprising an electricity credit calculated by said computer and owed to the farmer reflecting the amount of electricity generated by the plurality of solar panels and provided to a utility.

8. The system of claim 1, further comprising an electricity credit calculated by said computer and owed to the farmer reflecting the amount of electricity generated by the plurality of solar panels and provided to a utility.
